(19) United States
(12) Patent Application Publication
(10) Pub. No.: US 2026/0319120 A1
(43) Pub. Date: Oct. 15, 2026

(54) SEISMIC DATA AUGMENTATION

(71) Applicant: Saudi Arabian Oil Company, Dhahran (SA)

(72) Inventors: Halah A. Alasmri, Dhahran (SA); Abdulmohsen M. Alali, Dammam (SA); Yue Ma, Beijing (CN)

(21) Appl. No.: 19/175,540

(22) Filed: Apr. 10, 2025

(51) Int. Cl. G01V 1/50; G06N 3/0455

(52) U.S. Cl. CPC G01V 1/50; G06N 3/0455; G01V 2210/6222

(57) ABSTRACT

Disclosed are methods, systems, and computer-readable media to perform operations including receiving seismic data including seismic images, well logs, and horizons; performing an image-guided interpolation using the seismic data to generate a deterministic velocity model; converting, using a variational autoencoder (VAE), the deterministic velocity model to a fixed-length vector; and performing multiple forward simulations using the fixed-length vector to generate augmented seismic data comprising primary reflections, multiples, and a whole wave field.

### TECHNICAL FIELD

This disclosure relates generally to hydrocarbon exploration, drilling, and production, and more particularly to seismic data augmentation.

### BACKGROUND

Seismic data is often limited due to costs associated with capturing seismic data. Further, environmental and logistical challenges can limit available seismic data.

### SUMMARY

The present disclosure describes seismic data augmentation that can generate augmented seismic data that better represents the geostatistical properties of input seismic data.

According to one innovative aspect of the present disclosure, a method for seismic data augmentation implemented by one or more processors is disclosed. In one aspect, the method can include: receiving seismic data including seismic images, well logs, and horizons; performing an image-guided interpolation using the seismic data to generate a deterministic velocity model; converting, using a variational autoencoder (VAE), the deterministic velocity model to a fixed-length vector; and performing multiple forward simulations using the fixed-length vector to generate augmented seismic data comprising primary reflections, multiples, and a whole wave field.

Other aspects include devices, apparatuses, systems, and computer programs for performing the aforementioned method.

The innovative method can include other optional features. For example, in some implementations, the method further comprises selecting hard points from the seismic images, the well logs, and the horizons; and inputting the hard points to the VAE.

In some implementations, the method further comprises performing wavelet extraction to generate extracted wavelets; and performing the multiple forward simulations using the extracted wavelets.

In some implementations, the VAE includes an encoder configured to convert the deterministic velocity model into a stochastic velocity model represented by a probability distribution in a latent space, a sampling layer configured to sample a vector from the probability distribution, and a decoder configured to convert the sampled vector to the fixed-length vector in a data space.

In some implementations, wherein the probability distribution is a Gaussian distribution.

In some implementations, wherein the encoder comprises a convolutional layer configured to convert the deterministic velocity model into a feature map, and a global average pooling (GAP) layer configured to reduce a spatial dimension of the feature map to generate the stochastic velocity model.

In some implementations, wherein converting the deterministic velocity model to the fixed-length vector comprises converting the deterministic velocity model into a stochastic velocity model represented by a probability distribution in a latent space; sampling a vector from the probability distribution; and converting the sampled vector to the fixed-length vector in a data space.

In some implementations, wherein the fixed-length vector is a stratified multi-layer velocity model, wherein performing the multiple forward simulations further comprises constructing a reflection response recursively for each layer of the stratified multi-layer velocity model.

According to another innovative aspect of the present disclosure, a non-transitory, computer-readable medium storing one or more instructions executable by a computer system to perform one or more operations, comprising: receiving seismic data including seismic images, well logs, and horizons; performing an image-guided interpolation using the seismic data to generate a deterministic velocity model; converting, using a variational autoencoder (VAE), the deterministic velocity model to a fixed-length vector; and performing multiple forward simulations using the fixed-length vector to generate augmented seismic data comprising primary reflections, multiples, and a whole wave field.

In some implementations, the operations further comprising selecting hard points from the seismic images, the well logs, and the horizons; and inputting the hard points to the VAE.

In some implementations, the operations further comprising performing extraction to generate extracted wavelets; and performing the multiple forward simulations using the extracted wavelets.

In some implementations, the VAE includes an encoder configured to convert the deterministic velocity model into a stochastic velocity model represented by a probability distribution in a latent space, a sampling layer configured to sample a vector from the probability distribution, and a decoder configured to convert the sampled vector to the fixed-length vector in a data space.

In some implementations, wherein the probability distribution is a Gaussian distribution.

In some implementations, wherein the encoder comprises a convolutional layer configured to convert the deterministic velocity model into a feature map, and a global average pooling (GAP) layer configured to reduce a spatial dimension of the feature map to generate the stochastic velocity model.

In some implementations, wherein converting the deterministic velocity model to the fixed-length vector comprises converting the deterministic velocity model into a stochastic velocity model represented by a probability distribution in a latent space; sampling a vector from the probability distribution; and converting the sampled vector to the fixed-length vector in a data space.

In some implementations, wherein the fixed-length vector is a stratified multi-layer velocity model, wherein performing the multiple forward simulations further comprises constructing a reflection response recursively for each layer of the stratified multi-layer velocity model.

According to another innovative aspect of the present disclosure, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving seismic data including seismic images, well logs, and horizons; performing an image-guided interpolation using the seismic data to generate a deterministic velocity model; converting, using a variational autoencoder (VAE), the deterministic velocity model to a fixed-length vector; and performing multiple forward simulations using the fixed-length vector to generate augmented seismic data comprising primary reflections, multiples, and a whole wave field.

In some implementations, the operations further comprising selecting hard points from the seismic images, the well logs, and the horizons; and inputting the hard points to the VAE.

In some implementations, the operations further comprising performing wavelet extraction to generate extracted wavelets; and performing the multiple forward simulations using the extracted wavelets.

In some implementations, the VAE includes an encoder configured to convert the deterministic velocity model into a stochastic velocity model represented by a probability distribution in a latent space, a sampling layer configured to sample a vector from the probability distribution, and a decoder configured to convert the sampled vector to the fixed-length vector in a data space.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### BRIEF DESCRIPTION OF THE FIGURES

FIG. 1 illustrates a process for seismic data augmentation, according to some implementations.

FIG. 2 illustrates an architecture of Variational Autoencoder (VAE), according to some implementations.

FIG. 3 illustrates an N-layer velocity model for multiple forward simulation, according to some implementations.

FIG. 4 illustrates a flow chart of an example process for seismic data augmentation, according to one or more implementations.

FIG. 5 illustrates hydrocarbon production operations that include both one or more field operations and one or more computational operations, which exchange information and control exploration for the production of hydrocarbons, according to some implementations.

FIG. 6 is a schematic illustration of an example controller (or control system) that enables seismic data augmentation, according to some implementations.

### DETAILED DESCRIPTION

These disclosed techniques describe methods and systems for seismic data augmentation. Seismic data augmentation refers to generating new training data or enhancing existing data by applying various transformations. The seismic data augmentation involves image-guided interpolation (IGI), variational autoencoders (VAEs), and multiple forward simulations. By combining IGI, VAEs, and multiple forward simulations, the disclosed techniques can enhance the realism and diversity of seismic data, reducing computational complexity and enhancing data generation speed. Thus, the disclosed techniques can generate augmented seismic data that better represents the geostatistical properties of input seismic data including seismic images, horizons, and well logs.

IGI can interpolate well-log sample points (seismic velocity and density) to three-dimensional (3D) gridded data according to a structure of the seismic image. VAEs can generate a fixed-length vector associated with a stochastic velocity model while preserving spatial features, so that the augmentation data maintains the characteristics of the original input seismic data. The reflectivity forward simulation (RFS) can use the fixed-length vector to model the primary reflections, multiples, and a whole wave field.

The VAEs can streamline seismic data processing, reduce errors, and identify important features, thereby significantly boosting model performance. In examples, important features are characteristics or attributes of data that enable an understanding of the structure associated with the seismic data. The VAEs can solve the issue of seismic scattering caused by stochastic media, seismic multiples, and fluctuations. Unlike conventional seismic data augmentation approaches, the VAEs can encode and decode spatial features within seismic data, enabling capture of an essence and structure of seismic data by learning probabilistic distributions of the real seismic data rather than fitting arbitrary patterns. Through VAEs-based augmentation, the disclosed techniques can efficiently model high-dimensional seismic data from existing well logs, horizons, and seismic images, as well as seismic scattering caused by stochastic media, multiples, and wavelet fluctuations.

The multiple forward simulations use multiple one-dimensional (1D) generators based on reflectivity-based simulation. The multiple 1D generators can introduce coherent noises into the seismic data, expanding learning dimensions for deep learning algorithms. Coherent noises have a consistent and repetitive pattern, often related to a source, such as multiples or reverberations caused by seismic waves reflecting between subsurface layers.

Seismic data augmentation can facilitate interpretation of the subsurface and improve Machine Learning (ML) applications in geoscience. Seismic data augmentation can enable the identification and interpretation of subsurface features used to train ML algorithms to identify important elements while minimizing exploration risks. Subsurface features in seismic data represent geological structures beneath the Earth's surface. Seismic data augmentation can make subtle subsurface features more visible to experts, while enhancing Artificial Intelligence (AI)'s ability to detect uncommon geological patterns.

Conventional velocity models generated using Sequential Gaussian Simulation (SGS) may struggle to accurately represent a subsurface behavior, because the conventional seismic velocity models rely heavily on prior knowledge and assumptions about the subsurface geology. These conventional velocity models are often constructed based on simplified assumptions, which may overlook the subsurface inherent heterogeneity, thus failing to capture the underlying variability. The reliance on assumptions may lead to errors in velocity modeling, resulting in inconsistencies between the modeled seismic data and the observed seismic data. The inconsistencies may affect the generalization and robustness of the generated velocity models.

Conventional seismic data augmentation approaches like SGS, image-to-image translation, time shifting, etc., may fall short of accommodating complexities introduced by heterogeneous media, multiples, and fluctuations, which can lead to poor-quality seismic data augmentations.

Compared to the conventional SGS approach, the disclosed techniques can reduce computational complexity and enable faster data generation. Additionally, VAEs can learn lower-dimensional representations of the seismic data, which can reduce overfitting and improve model performance. The disclosed techniques can be used in multiple geophysical applications, from inverting elastic properties with deep learning to predicting facies. Inversion involves estimating these properties from seismic reflection data. Facies represent distinct geological units with characteristic properties, such as lithology (rock type), porosity, and fluid content. The disclosed techniques not only refine data quality but also enrich the machine learning models' training process, resulting in more accurate and efficient geophysical analysis.

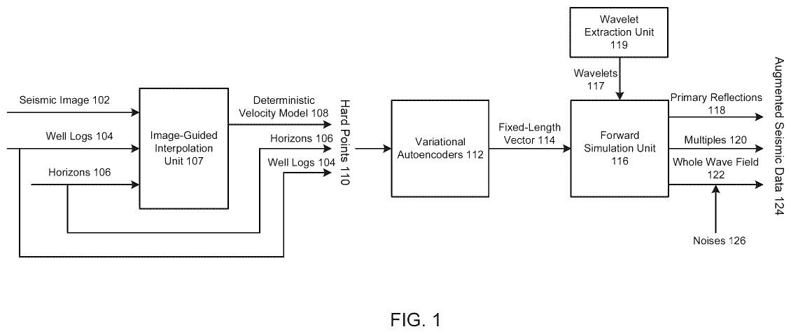

FIG. 1 illustrates an example process for seismic data augmentation, according to some implementations. Seismic images 102, well logs 104, and horizons 106 are input into IGI unit 107. Seismic images 102 are generated from seismic reflection data and provide a 2D or 3D visualization of the subsurface. The seismic images 102 display geological features like faults, folds, salt domes, and stratigraphic layers. Well logs 104 provide point-based data collected from boreholes, including detailed information about the properties of the rock and fluids at specific locations. The well logs 104 can complement seismic images 102 by providing high-resolution, direct measurements. Horizons 106 are seismic reflectors representing geological boundaries, such as stratigraphic interfaces (e.g., the boundary between sandstone and shale), and structural boundaries (e.g., fault planes or unconformities). IGI unit 107 outputs a deterministic velocity model 108. A deterministic velocity model 108 represents a spatial distribution of wave velocities (P-wave and S-wave) in the Earth's subsurface. The deterministic velocity model 108 refers to a velocity model that is generated using known, fixed input data without incorporating randomness or multiple realizations. The same input data leads to the same output velocity model. The deterministic velocity model 108 outputted from the IGI unit 107 is a smoothed and interpolated version of a velocity model based on the well logs 104, seismic images 102, and horizons 106. Hard points 110 are selected from well logs 104, horizons 106, and deterministic velocity model 108. Hard points refer to fixed, known data points where the values (e.g., velocity, depth, or other properties) are directly measured and considered highly reliable.

Hard points selection depends on several factors, including the spatial variability of the deterministic velocity model 108, the intended accuracy of the simulation (e.g., forward simulation performed by forward simulation unit 116), and the available computational resources. The intended accuracy refers to how closely the simulated velocity model (e.g., fixed-length vector 114) can match the real geological or subsurface conditions. The intended accuracy can ensure that the simulation captures the required level of geological details and variability. Hard points selected from well logs 104 provide direct measurements of velocities at specific locations. Extracted hard points from interpreted horizons 106 contain information about geological boundaries that guide the simulation. Randomly selected hard points from the deterministic velocity model 108 can balance the coverage and constrain the process performed by the VAE 112, especially when well control is sparse. These hard points 110 are used as constraints in an encoder network included in the VAE 112, so that a stochastic velocity model generated by an encoder network aligns with known geological features while introducing realistic variability. Hard points selected from well logs 104 are generated by retrieving well trajectory indices, two-way travel times (TWT), and velocities from a well data dictionary. The hard points selected from well logs 104 are a combination of inline index, crossline index, TWT index, and velocity values extracted from each well's data. The hard points extracted from horizons 106 are a combination of adjusted inline index, crossline index, and TWT index values for each valid point on the horizon surfaces.

Hard points 110 are input into VAEs 112. A VAE is a type of generative neural network that learns to model complex data distributions. Unlike standard autoencoders, VAEs can generate new, meaningful data samples similar to the input data. A VAE includes an encoder, a sampling layer, and a decoder. The encoder maps input data to a latent space representation by encoding the input data into a probability distribution (a mean vector and a standard deviation vector (e.g., a log-variance vector)). Instead of directly outputting a compressed representation, the encoder outputs parameters of a Gaussian distribution. The sampling layer generates a latent vector by drawing a sample from the Gaussian distribution defined by the mean vector and the log-variance vector. The decoder generates data that closely resembles the original input data from a sample of the latent vector, learning to approximate the underlying data distribution. A fixed-length vector 114 is output from VAEs 112 and input into forward simulation unit 116. In some implementations, the extracted wavelets 117 from wavelet extraction unit 119 are also input into forward simulation unit 116. Wavelet extraction provides a realistic estimate of a seismic wavelet from recorded seismic data.

The forward simulation unit 116 performs multiple forward simulations. Multiple forward simulations refer to repeatedly simulating seismic wave propagation (or other physical processes) on the subsurface using varying input parameters or models. Multiple forward simulations are used to understand how changes in parameters (e.g., velocity, density, or geometry) affect seismic responses, enabling for better prediction, analysis, and modeling of real-world seismic data. The forward simulation unit 116 outputs primary reflections 118, multiples 120, and the whole wave field 122. Primary reflections 118 are seismic waves that travel directly from the source, reflect off a single subsurface boundary (e.g., between two rock layers), and return to the surface without any additional internal reflections. Multiples 120 are seismic waves that undergo multiple reflections within the subsurface before returning to the surface. The whole wave field 122 refers to a complete set of seismic wave events (e.g., including both primary and multiple reflections, up-going wavefields, down-going wavefields, etc.) captured during a survey. The primary reflections 118, multiples 120, and the whole wave field 122 constitute augmented seismic data 124.

In some implementations, augmented seismic data 124 further includes noises 126. In examples, noises 126 are generated by multiple 1D generators (1D reflectivity forward modeling) according to reflectivity-based simulation. The noises 126 refer to background noises or random noises that are added to the synthetic data additionally to increase the realism of the augmented seismic data 124. The noises 126 can enhance the diversity of the augmented seismic data 124, making it more representative of real-world scenarios. Adding noise 126 can increase the realism of the synthetic seismic data (e.g., augmented seismic data 124).

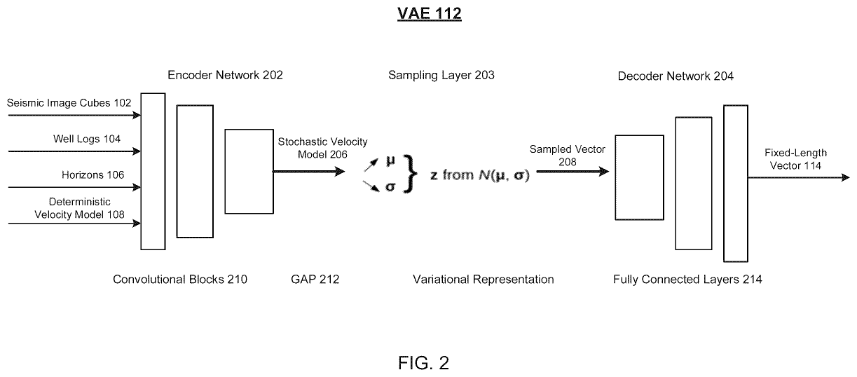

FIG. 2 illustrates an architecture of VAE 112, according to some implementations. The VAE 112 includes an encoder network 202, a sampling layer 203, and a decoder network 204. The input data includes seismic image cubes 102, well logs 104, horizons 106, and smooth deterministic velocity model 108 output from image-guided interpolation (IGI) unit 107. The encoder network 202 includes a sequence of convolutional layers 210 and global average pooling (GAP) layers 212. A convolutional layer 210 applies a set of filters (kernels) to the input data, extracts important features like edges, patterns, and textures from images or other structured data, and converts the input data into a feature map. A GAP layer 212 is a type of pooling layer used in Convolutional Neural Networks (CNNs). The GAP layer 212 can reduce the spatial dimensions (height and width) of a feature map to 1×1, thereby compressing each feature map channel to a single scalar value by averaging all its elements. The encoder network 202 learns to map the input data to a zero-centered Gaussian distribution with unit diagonal variance.

The encoder network 202 converts the input data into a probability distribution in a latent space (e.g., a stochastic velocity model 206 that is a probabilistic representation of the seismic velocity distribution in the subsurface). A probabilistic encoding of the latent code generated by the encoder network 202 enables the VAE 112 to describe not only a single point in the latent space but also a distribution of potential representations, including a mean vector and a log-variance vector. The stochastic velocity model 206 accounts for uncertainty and variability by generating multiple possible realizations that are consistent with both the input data and spatial correlation structures.

The sampling layer 203 uses a variational formulation that incorporates a stochastic regularization to improve model generalization. The sampling layer 203 samples a vector from the distribution, and the sampled vector 208 is transmitted to the decoder network 204. Using a mean vector μ and a standard deviation vector σ, the sampling of a vector z is obtained with the re-parameterization trick using Equation (1).

z=∈*σ+μ, (1)
where ∈ is a noise vector sampled from the unit Gaussian. The sampling algorithm is compatible with a back-propagation algorithm used to train neural networks. In addition to having a regularization effect that is potentially beneficial to reduce overfitting, the variational setting can be used to account for uncertainties of the deconvolution process. The variational formulation addresses the ambiguity in the stochastic velocity model 206.

The decoder network 204 can reconstruct a sampled vector 208 from the latent distribution into the data space, and output a fixed-length vector 114. The decoder network 204 includes a chain of fully connected layers 214 (e.g., two fully connected layers). To minimize reconstruction loss and regularize the latent space to meet the distribution requirements, the VAE 112 is trained to refine both the encoder 202 and decoder 204 parameters. In some implementations, Kullback-Leibler (KL) divergence is utilized to balance between the reconstruction loss and the regularization term. The VAE 112 is trained to reconstruct the input data while ensuring that the latent space adheres to the chosen distribution, thereby preventing overfitting and promoting generalization. During training, encoder 202 and decoder 204 parameters are adjusted iteratively so that the VAE 112 can encode input data into a representation of latent space, and the underlying features and structures of the input data are encapsulated within an optimized latent code, enabling a precise reconstruction of the input data.

Referring back to FIG. 1, the forward simulation unit 116 employs reflectivity forward modeling to synthesize seismic data, e.g., to construct the reflection response of a stratified medium through a two-stage recursive process for incident downgoing waves. Given N uniform layers with velocity model v(zᵢ), where zᵢ is the depth of the i-th reflector, i=1, . . . , N, the reflection and transmission coefficients at each interface for incident downgoing and upgoing waves are denoted as

$${r}_{d}^{i} , {t}_{d}^{i} , {r}_{u}^{i} , {t}_{u}^{i} ,$$

respectively. Density is ignored for simplicity. Starting from the bottom layer, the forward simulation unit 116 calculates the reflection coefficient

$${R}_{d} ( {z}_{N - 1}^{-} ) = {r}_{d}^{N - 1} ,$$

where

$${z}_{N - 1}^{-}$$

indicates the depth just above the layer z_{N-1}. The phase terms are then added to calculate the reflection just below the layer

$${z}_{N - 2}^{+}$$

using Equation (2).

$${R}_{d} ( {z}_{N - 2}^{+} ) = {E}_{d}^{N - 1} {R}_{d} ( {z}_{N - 1}^{-} ) {E}_{u}^{N - 1} , \qquad ( 2 )$$

where the phase term depends on the frequency ω and velocity as shown in Equation (3).

$${E}_{d}^{N - 1} = {E}_{u}^{N - 1} = {e}^{\frac{i ω ( {z}_{N - 1} - {z}_{N - 2} )}{v ( {z}_{N - 1} )}} . \qquad ( 3 )$$

After incorporating the interface at z_{N-2}, the reflection is brought to the upper side of the layer at

$${z}_{N - 2}^{-}$$

using Equation (4).

$${R}_{d} ( {z}_{N - 2}^{-} ) = {r}_{d}^{N - 2} + \frac{{t}_{d}^{N - 2} {R}_{d} ( {z}_{N - 2}^{+} ) {t}_{u}^{N - 2}}{1 - {r}_{u}^{N - 2} {R}_{d} ( {z}_{N - 2}^{+} )} . \qquad ( 4 )$$

The denominator

$${( 1 - {r}_{u}^{N - 2} {R}_{d} ( {z}_{N - 2}^{+} ) )}^{- 1}$$

represents the cumulative effect of a sequence of internal reverberations, including primary reflections and infinite orders of internal multiples. A Taylor series expansion of this term is provided using Equation (5).

$${( 1 - {r}_{u}^{N - 2} {R}_{d} ( {z}_{N - 2}^{+} ) )}^{- 1} = 1 + {r}_{u}^{N - 2} {E}_{u}^{N - 1} {R}_{d} ( {z}_{N - 1}^{-} ) {E}_{d}^{N - 1} + {r}_{u}^{N - 2} {E}_{u}^{N - 1} {R}_{d} ( {z}_{N - 1}^{-} ) {E}_{d}^{N - 1} {r}_{u}^{N - 2} {E}_{u}^{N - 1} {R}_{d} ( {z}_{N - 1}^{-} ) {E}_{d}^{N - 1} + ⋯ . \qquad ( 5 )$$

The zero-order expansion of the Taylor series in Equation (5) indicates a primary reflection. The first-order expansion

$${r}_{u}^{N - 2} {E}_{u}^{N - 1} {R}_{d} ( {z}_{N - 1}^{-} ) {E}_{d}^{N - 1}$$

refers to the first-order internal multiple. High-order terms arise from the sequence of internal reverberations within the z_{N+2} layer.

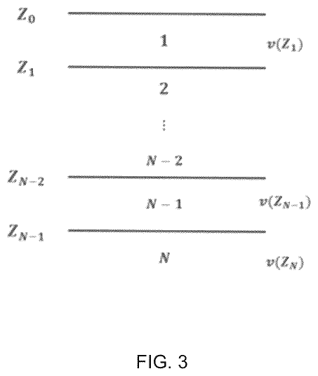

The above Equations (2)-(5) enable construction of the reflection response recursively, a layer at a time for a stratified multi-layer velocity model. FIG. 3 illustrates an N-layer velocity model for multiple forward simulation, according to some implementations. A synthetic seismic trace is generated by an inverse Fourier transform of the products of different monochromatic impulse responses with a source wavelet.

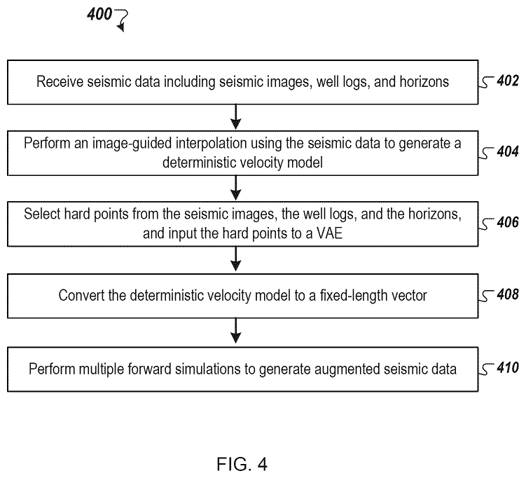

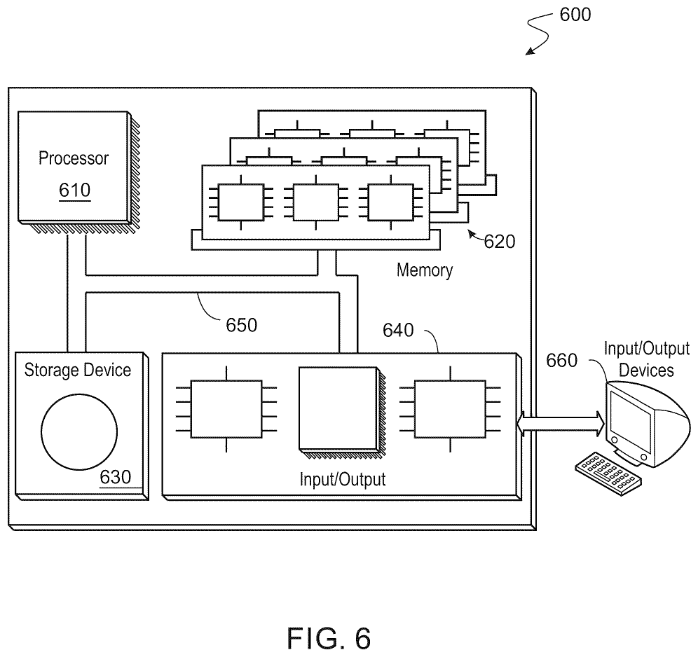

FIG. 4 illustrates a flow chart of an example process for seismic data augmentation, according to one or more implementations. Process 400 is described as being performed by a computing device including one or more processors or a controller, such as controller 600 of FIG. 6. The example process 400 shown in FIG. 4 can be modified or reconfigured to include additional, fewer, or different steps (not shown in FIG. 4), which can be performed in the order shown or in a different order.

At 402, the controller receives seismic data including seismic images (e.g., seismic images 102), well logs (e.g., well logs 104), and horizons (e.g., horizons 106).

At 404, the controller performs an image-guided interpolation (e.g., by image-guided interpolation unit 107) using the seismic data to generate a deterministic velocity model (e.g., deterministic velocity model 108).

At 406, the controller selects hard points (e.g., hard points 110) from the seismic images, the well logs, and the horizons, and inputs the hard points to a VAE (e.g., VAE 112).

At 408, the controller converts, using the VAE, the deterministic velocity model to a fixed-length vector (e.g., fixed-length vector 114).

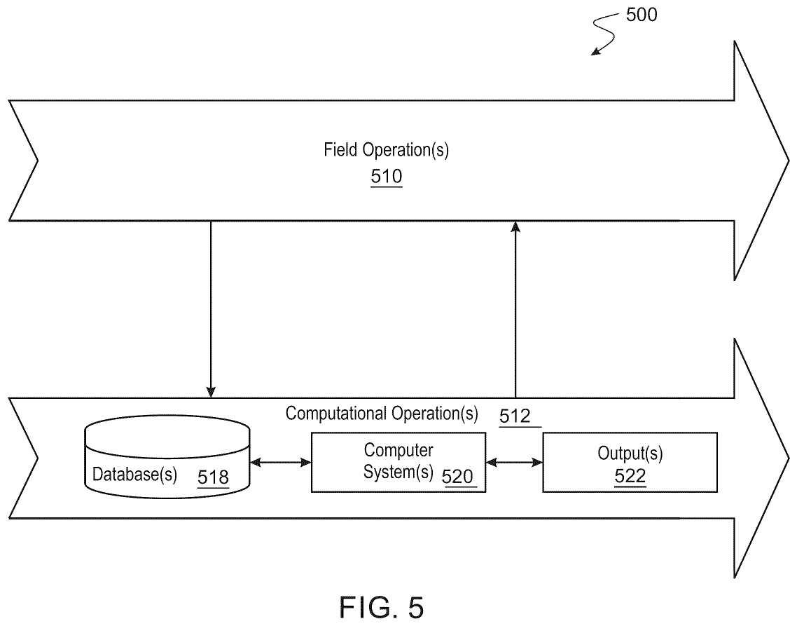

At 410, the controller performs multiple forward simulations (e.g., by forward simulation unit 116) using the fixed-length vector to generate augmented seismic data (e.g., augmented seismic data 124) including primary reflections (e.g., primary reflections 118), multiples (e.g., multiples 120), and a whole wave field (e.g., whole wave field 122). In some embodiments, the augmented seismic data is used to specify accurate and detailed information about the subsurface. This information is used in hydrocarbon exploration, drilling, and production activities. For example, the augmented seismic data is used in hydrocarbon production operations 500 of FIG. 5. In examples, elastic properties of the subsurface are estimated using the augmented seismic data. Additionally, in examples, facies of the subsurface are estimated using augmented seismic data.

In examples, augmented seismic data improves the accuracy and efficiency of geophysical applications, such as seismic data interpretation. For example, augmented seismic data enables better imaging of subsurface structures, leading to more accurate identification of hydrocarbon reservoirs. Augmented seismic data enhances the performance of computational models and algorithms used in seismic data processing. Thus, augmented seismic data reduces time and computational resources consumed through enhanced performance of computational models and algorithms used in seismic data processing.

In some implementations, the controller further performs wavelet extraction (e.g., by wavelet extraction unit 119) to generate extracted wavelets (e.g., wavelets 117), and multiple forward simulations are performed using the extracted wavelets.

In some implementations, the VAE includes an encoder (e.g., encoder network 202) configured to convert the deterministic velocity model (e.g., deterministic velocity model 108) into a stochastic velocity model (e.g., stochastic velocity model 206) represented by a probability distribution in a latent space, a sampling layer (e.g., sampling layer 203) configured to sample a vector from the probability distribution, and a decoder (e.g., decoder network 204) configured to convert the sampled vector (e.g., sampled vector 208) to the fixed-length vector (e.g., fixed-length vector 114) in a data space. In some implementations, the probability distribution is a Gaussian distribution.

In some implementations, the encoder includes a convolutional layer (e.g., convolutional block 210) configured to convert the deterministic velocity model into a feature map, and a global average pooling (GAP) layer (e.g., GAP layer 212) configured to reduce a spatial dimension of the feature map to generate a stochastic velocity model (e.g., stochastic velocity model 206).

In some implementations, to convert the deterministic velocity model to the fixed-length vector, the controller converts the deterministic velocity model into a stochastic velocity model represented by a probability distribution in a latent space, samples a vector from the probability distribution, and converts the sampled vector to the fixed-length vector in a data space.

In some implementations, the fixed-length vector is a stratified multi-layer velocity model. To perform the multiple forward simulations, the controller constructs a reflection response recursively for each layer of the stratified multi-layer velocity model.

FIG. 5 illustrates hydrocarbon production operations 500 that include both one or more field operations 510 and one or more computational operations 512, which exchange information and control exploration for the production of hydrocarbons, according to some implementations. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, and injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively, or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the Earth, and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real time.

The one or more computer systems 520 can update the 3D maps of the subsurface formation as information from one exploration well is received, and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery, and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 6 is a schematic illustration of an example controller 600 (or control system) that enables seismic data augmentation, according to some implementations. For example, the controller 600 may be operable according to the process 4 of FIG. 4. The controller 600 is intended to include various forms of digital computers, such as printed circuit boards (PCB), processors, digital circuitry, or otherwise parts of a system for supply chain alert management. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output interface 640 communicatively coupled with input/output devices 660 (for example, displays, keyboards, measurement devices, sensors, valves, pumps). Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output interface 640.

The memory 620 stores information within the controller 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output interface 640 provides input/output operations for the controller 600. In one implementation, the input/output devices 660 include a keyboard and/or pointing device. In another implementation, the input/output devices 660 includes a display unit for displaying graphical user interfaces.

There can be any number of controllers 600 associated with, or external to, a computer system containing controller 600, with each controller 600 communicating over a network. Further, the terms “client,” “user,” and other appropriate terminology can be used interchangeably, as appropriate, without departing from the scope of the present disclosure. Moreover, the present disclosure contemplates that many users can use one controller 600, and one user can use multiple controllers 600.

### EMBODIMENTS/EXAMPLES

According to some non-limiting embodiments or examples, provided is a computer-implemented method for seismic data augmentation implemented by one or more processors, comprising: receiving seismic data including seismic images, well logs, and horizons; performing an image-guided interpolation using the seismic data to generate a deterministic velocity model;

converting, using a variational autoencoder (VAE), the deterministic velocity model to a fixed-length vector; and performing multiple forward simulations using the fixed-length vector to generate augmented seismic data comprising primary reflections, multiples, and a whole wave field.

According to some non-limiting embodiments or examples, provided is an apparatus comprising a non-transitory, computer readable, storage medium that stores instructions that, when executed by at least one processor, cause the at least one processor to perform operations comprising: receiving seismic data including seismic images, well logs, and horizons; performing an image-guided interpolation using the seismic data to generate a deterministic velocity model; converting, using a variational autoencoder (VAE), the deterministic velocity model to a fixed-length vector; and performing multiple forward simulations using the fixed-length vector to generate augmented seismic data comprising primary reflections, multiples, and a whole wave field.

According to some non-limiting embodiments or examples, provided is a system, comprising: one or more memory modules; and one or more hardware processors communicably coupled to the one or more memory modules, the one or more hardware processors configured to execute instructions stored on the one or more memory modules to perform operations comprising: receiving seismic data including seismic images, well logs, and horizons; performing an image-guided interpolation using the seismic data to generate a deterministic velocity model; converting, using a variational autoencoder (VAE), the deterministic velocity model to a fixed-length vector; and performing multiple forward simulations using the fixed-length vector to generate augmented seismic data comprising primary reflections, multiples, and a whole wave field.

Further non-limiting aspects or embodiments are set forth in the following numbered embodiments:

Embodiment 1: A computer-implemented method for implementation by one or more processors, the method comprising: receiving seismic data including seismic images, well logs, and horizons; performing an image-guided interpolation using the seismic data to generate a deterministic velocity model; converting, using a variational autoencoder (VAE), the deterministic velocity model to a fixed-length vector; and performing multiple forward simulations using the fixed-length vector to generate augmented seismic data comprising primary reflections, multiples, and a whole wave field.

Embodiment 2: The computer-implemented method of Embodiment 1, further comprising selecting hard points from the seismic images, the well logs, and the horizons; and inputting the hard points to the VAE.

Embodiment 3: The computer-implemented method of Embodiment 1 or 2, further comprising performing wavelet extraction to generate extracted wavelets; and performing the multiple forward simulations using the extracted wavelets.

Embodiment 4: The computer-implemented method of any one of Embodiments 1-3, the VAE includes an encoder configured to convert the deterministic velocity model into a stochastic velocity model represented by a probability distribution in a latent space, a sampling layer configured to sample a vector from the probability distribution, and a decoder configured to convert the sampled vector to the fixed-length vector in a data space.

Embodiment 5: The computer-implemented method of Embodiment 4, wherein the probability distribution is a Gaussian distribution.

Embodiment 6: The computer-implemented method of Embodiment 4, wherein the encoder comprises a convolutional layer configured to convert the deterministic velocity model into a feature map, and a global average pooling (GAP) layer configured to reduce a spatial dimension of the feature map to generate the stochastic velocity model.

Embodiment 7: The computer-implemented method of any one of Embodiments 1-6, wherein converting the deterministic velocity model to the fixed-length vector comprises converting the deterministic velocity model into a stochastic velocity model represented by a probability distribution in a latent space; sampling a vector from the probability distribution; and converting the sampled vector to the fixed-length vector in a data space.

Embodiment 8: The computer-implemented method of any one of Embodiments 1-7, wherein the fixed-length vector is a stratified multi-layer velocity model, wherein performing the multiple forward simulations further comprises constructing a reflection response recursively for each layer of the stratified multi-layer velocity model.

Embodiment 9: A non-transitory, computer-readable medium storing one or more instructions executable by a computer system to perform one or more operations comprising: receiving seismic data including seismic images, well logs, and horizons; performing an image-guided interpolation using the seismic data to generate a deterministic velocity model; converting, using a variational autoencoder (VAE), the deterministic velocity model to a fixed-length vector; and performing multiple forward simulations using the fixed-length vector to generate augmented seismic data comprising primary reflections, multiples, and a whole wave field.

Embodiment 10: The non-transitory, computer-readable medium of Embodiment 9, the operations further comprising selecting hard points from the seismic images, the well logs, and the horizons; and inputting the hard points to the VAE.

Embodiment 11: The non-transitory, computer-readable medium of Embodiment 9 or 10, the operations further comprising performing wavelet extraction to generate extracted wavelets; and performing the multiple forward simulations using the extracted wavelets.

Embodiment 12: The non-transitory, computer-readable medium of any one of Embodiments 9-11, the VAE includes an encoder configured to convert the deterministic velocity model into a stochastic velocity model represented by a probability distribution in a latent space, a sampling layer configured to sample a vector from the probability distribution, and a decoder configured to convert the sampled vector to the fixed-length vector in a data space.

Embodiment 13: The non-transitory, computer-readable medium of Embodiment 12, wherein the probability distribution is a Gaussian distribution.

Embodiment 14: The non-transitory, computer-readable medium of Embodiment 12, wherein the encoder comprises a convolutional layer configured to convert the deterministic velocity model into a feature map, and a global average pooling (GAP) layer configured to reduce a spatial dimension of the feature map to generate the stochastic velocity model.

Embodiment 15: The non-transitory, computer-readable medium of any one of Embodiments 9-14, wherein converting the deterministic velocity model to the fixed-length vector comprises converting the deterministic velocity model into a stochastic velocity model represented by a probability distribution in a latent space; sampling a vector from the probability distribution; and converting the sampled vector to the fixed-length vector in a data space.

Embodiment 16: The non-transitory, computer-readable medium of any one of Embodiments 9-15, wherein the fixed-length vector is a stratified multi-layer velocity model, wherein performing the multiple forward simulations further comprises constructing a reflection response recursively for each layer of the stratified multi-layer velocity model.

Embodiment 17: A computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving seismic data including seismic images, well logs, and horizons; performing an image-guided interpolation using the seismic data to generate a deterministic velocity model; converting, using a variational autoencoder (VAE), the deterministic velocity model to a fixed-length vector; and performing multiple forward simulations using the fixed-length vector to generate augmented seismic data comprising primary reflections, multiples, and a whole wave field.

Embodiment 18: The computer-implemented system of Embodiment 17, the operations further comprising selecting hard points from the seismic images, the well logs, and the horizons; and inputting the hard points to the VAE.

Embodiment 19: The computer-implemented system of Embodiment 17 or 18, the operations further comprising performing wavelet extraction to generate extracted wavelets; and performing the multiple forward simulations using the extracted wavelets.

Embodiment 20: The computer-implemented system of any one of Embodiments 17-19, the VAE includes an encoder configured to convert the deterministic velocity model into a stochastic velocity model represented by a probability distribution in a latent space, a sampling layer configured to sample a vector from the probability distribution, and a decoder configured to convert the sampled vector to the fixed-length vector in a data space. Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Various components may be described as performing a task or tasks, for convenience in the description. Such descriptions should be interpreted as including the phrase “configured to.” Reciting a component that is configured to perform one or more tasks is expressly intended not to invoke 35 USC § 112 (f) interpretation for that component.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

We claim:

1. A computer-implemented method for implementation by one or more processors, the method comprising:
receiving seismic data including seismic images, well logs, and horizons;
performing an image-guided interpolation using the seismic data to generate a deterministic velocity model;
converting, using a variational autoencoder (VAE), the deterministic velocity model to a fixed-length vector; and
performing multiple forward simulations using the fixed-length vector to generate augmented seismic data comprising primary reflections, multiples, and a whole wave field.

2. The computer-implemented method of claim 1, further comprising
selecting hard points from the seismic images, the well logs, and the horizons; and
inputting the hard points to the VAE.

3. The computer-implemented method of claim 1, further comprising
performing wavelet extraction to generate extracted wavelets; and
performing the multiple forward simulations using the extracted wavelets.

4. The computer-implemented method of claim 1, the VAE includes an encoder configured to convert the deterministic velocity model into a stochastic velocity model represented by a probability distribution in a latent space, a sampling layer configured to sample a vector from the probability distribution, and a decoder configured to convert the sampled vector to the fixed-length vector in a data space.

5. The computer-implemented method of claim 4, wherein the probability distribution is a Gaussian distribution.

6. The computer-implemented method of claim 4, wherein the encoder comprises a convolutional layer configured to convert the deterministic velocity model into a feature map, and a global average pooling (GAP) layer configured to reduce a spatial dimension of the feature map to generate the stochastic velocity model.

7. The computer-implemented method of claim 1, wherein converting the deterministic velocity model to the fixed-length vector comprises
converting the deterministic velocity model into a stochastic velocity model represented by a probability distribution in a latent space;
sampling a vector from the probability distribution; and
converting the sampled vector to the fixed-length vector in a data space.

8. The computer-implemented method of claim 1, wherein the fixed-length vector is a stratified multi-layer velocity model, wherein performing the multiple forward simulations further comprises
constructing a reflection response recursively for each layer of the stratified multi-layer velocity model.

9. A non-transitory, computer-readable medium storing one or more instructions executable by a computer system to perform one or more operations comprising:
receiving seismic data including seismic images, well logs, and horizons;
performing an image-guided interpolation using the seismic data to generate a deterministic velocity model;
converting, using a variational autoencoder (VAE), the deterministic velocity model to a fixed-length vector; and
performing multiple forward simulations using the fixed-length vector to generate augmented seismic data comprising primary reflections, multiples, and a whole wave field.

10. The non-transitory, computer-readable medium of claim 9, the operations further comprising
selecting hard points from the seismic images, the well logs, and the horizons; and
inputting the hard points to the VAE.

11. The non-transitory, computer-readable medium of claim 9, the operations further comprising
performing wavelet extraction to generate extracted wavelets; and
performing the multiple forward simulations using the extracted wavelets.

12. The non-transitory, computer-readable medium of claim 9, the VAE includes an encoder configured to convert the deterministic velocity model into a stochastic velocity model represented by a probability distribution in a latent space, a sampling layer configured to sample a vector from the probability distribution, and a decoder configured to convert the sampled vector to the fixed-length vector in a data space.

13. The non-transitory, computer-readable medium of claim 12, wherein the probability distribution is a Gaussian distribution.

14. The non-transitory, computer-readable medium of claim 12, wherein the encoder comprises a convolutional layer configured to convert the deterministic velocity model into a feature map, and a global average pooling (GAP) layer configured to reduce a spatial dimension of the feature map to generate the stochastic velocity model.

15. The non-transitory, computer-readable medium of claim 9, wherein converting the deterministic velocity model to the fixed-length vector comprises
converting the deterministic velocity model into a stochastic velocity model represented by a probability distribution in a latent space;
sampling a vector from the probability distribution; and
converting the sampled vector to the fixed-length vector in a data space.

16. The non-transitory, computer-readable medium of claim 9, wherein the fixed-length vector is a stratified multi-layer velocity model, wherein performing the multiple forward simulations further comprises
constructing a reflection response recursively for each layer of the stratified multi-layer velocity model.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving seismic data including seismic images, well logs, and horizons;
performing an image-guided interpolation using the seismic data to generate a deterministic velocity model;
converting, using a variational autoencoder (VAE), the deterministic velocity model to a fixed-length vector; and
performing multiple forward simulations using the fixed-length vector to generate augmented seismic data comprising primary reflections, multiples, and a whole wave field.

18. The computer-implemented system of claim 17, the operations further comprising selecting hard points from the seismic images, the well logs, and the horizons; and
inputting the hard points to the VAE.

19. The computer-implemented system of claim 17, the operations further comprising performing wavelet extraction to generate extracted wavelets; and
performing the multiple forward simulations using the extracted wavelets.

20. The computer-implemented system of claim 17, the VAE includes an encoder configured to convert the deterministic velocity model into a stochastic velocity model represented by a probability distribution in a latent space, a sampling layer configured to sample a vector from the probability distribution, and a decoder configured to convert the sampled vector to the fixed-length vector in a data space.
